(19) United States
(12) Patent Application Publication
(10) Pub. No.: US 2002/0083476 A1
(43) Pub. Date: Jun. 27, 2002

(54) Method and apparatus for reducing the flow of RF noise from subscriber's premise cable systems into the reverse transmission path of two-way cable networks

(76) Inventor: Robert McNamara, San Jose, CA (US)

Correspondence Address: ROBERT P. McNAMARA, 836 TATRA CT, SAN JOSE, CA, 95136, US

(21) Appl. No.: 09/804,872

(22) Filed: Mar. 13, 2001

Related U.S. Application Data
(60) Provisional application No. 60/190,868, filed on Mar. 21, 2000.

(51) Int. Cl. H04N 7/16

(52) U.S. Cl. 725/148

(57) ABSTRACT

What is disclosed is a method and means for reducing the RF noise induced within cable networks within residences or businesses from entering hybrid fiber optic coax networks in the reverse (upstream) direction. The active unit consists of a set of diplex filters connected end to end which segregates the RF traffic into a forward (nominally 50-750/850 MHz) and a reverse (nominally 5-30/36/42 MHz) direction but with an amplifier placed in the low band path. In the simplest embodiment, the active unit is attached directly to an Network Interface Unit (NIU). Signals from the NIU are amplified as they pass through the active unit and are then transmitted through the premise distribution network. The active unit is designed to boost the signals before they are mixed with noise present within the subscriber's premise network. At a second point in the network, typically at the side of the home where the residential premise network connects to the outside cable plant, the network passes through a second passive unit. The passive unit consists of a pair of diplex filters but on the low band path of the diplex filter pair there is an attenuator which attenuates signals in the reverse direction by nominally 15-35 dB, depending upon the value chosen for the attenuator. The attenuator may be either fixed, variable, or a combination of both and will be chosen by the design rules described below. The amplified RF signal and all noise that has entered the premise network cable system in the reverse path are attenuated and then passed through to the outside cable plant.

### BACKGROUND OF INVENTION

This invention relates to the field of telecommunications in general and the reduction of RF noise induced within cable networks within residences or businesses from entering hybrid fiber optic coax networks in the reverse (upstream) direction.

Currently, traditional coaxial cable networks are being upgraded from one way broadcast systems to two-way communications networks. The upgrade process consists of nominally extending fiber optics into the cable plant to create nodes or sub-networks of approximately 400-500 homes (or subscribers) passed per node, enabling the upstream or return communications path by installing reverse amplifiers into the cable plant and a return laser in the fiber node, and tightening the cable plant to preclude or minimize stray RF signals from interfering with the return RF signals. In most US based two-way cable systems, the RF bandwidth from 5-30/36/42 MHz is allocated as the “return path” of the RF cable spectrum supporting communications from cable system users to the cable system headend. The choice of this particular portion of return spectrum is one part historical (mandated by the FCC in the 1960s) and one part practical. The first channel on most US based cable systems, Channel 2, begins at 54 MHz and the bandwidth from 50-750/850 MHz is used for a variety of analog and digital services. Therefore, the RF spectrum from 5-30/36/42 MHz turns out to be the only RF bandwidth on the cable system not allocated for broadcast analog or digital video channels and, by default, is used for communication from the subscriber's premise to the cable system headend.

To utilize this return bandwidth, subscribers' premise cable networks are connected to an external, two-way activated, Hybrid Fiber Coaxial (HFC) network, typically at the side of the residence or business, and are given a two-way enabled device, either in the form of a set top box or cable data modem which is installed within the premises. This two way enabled unit, regardless of function, is designated here as a Network Interface Unit or NIU. This device transmits an RF signal on a particular portion of the upstream RF spectrum which passes through the subscriber's premise cable network and onto the return RF path of the external HFC network. Typically, the upstream RF bandwidth on the cable system is shared by many users through a combination bandwidth sharing schemes such as Frequency Division Multiplexing (FDM), Time Division Multiplexing (TDM), Code Division Multiplex Access (CDMA), or the Data Over Cable Service Interface Specifications (DOCSIS), among others. The problem that cable system operators face today is that the low band RF spectrum is highly susceptible to leakage of unwanted stray signals and RF interference from a variety of sources (collectively labeled “Ingress Noise”). These unwanted RF noise signals can either enter the return cable spectrum of the premise distribution network or can be superimposed on transmitted return signals from NIUs and then transferred onto the return RF path of the outside cable plant. The effect of this Ingress Noise is to degrade both the transmitted signal from the originating subscriber's premise as well as all other users of two way service on that particular fiber node or part of the cable plant. In a worst case situation, no usable return signals may be received from a particular fiber node and all two-way communications capability is lost.

This invention is designed to limit the degradation of the overall return path by reducing unwanted RF Ingress Noise signals from exiting the residential or business premise cable network and entering the external cable plant.

The reason that Ingress Noise in the return RF band is the dominant problem facing network operators is two-fold. First, use of the lower portion of the RF spectrum of a cable system (5-30/42 MHz) for return path transmissions has one serious side effect, the outer conductor of the coaxial cable does not shield as effectively in this low band as it does at higher frequencies. This can be understood in terms of the skin or penetration depth of the outer conductor, which determines how rapidly electromagnetic signals are damped or attenuated within the outside conductor. Since the skin depth of an electromagnetic signal is inversely proportional to the square root of the frequency, the higher the frequency, the smaller the skin depth, and the greater the shielding. Stated another way, at lower frequencies the cable's shielding is more ineffective and more susceptible to picking up unwanted signals than at higher frequencies.

Second, signals on the return path of a cable network are directed or “funneled” towards the headend of the cable network. This funneling is due to the unique architecture of cable systems. In the forward direction the cable system consists of a single transmitter located at the cable system headend and multiple receivers. In the reverse direction, the exact opposite is true. In the reverse direction, a cable system consists of multiple transmitters (and noise sources) and a single receiver located at the cable system headend. Since the transmission path from all transmitters in the reverse direction to the cable system headend is shared by all users of a particular Fiber Node, signals and noise from any one source (in essence a home or business premise network) is added and superimposed on the signals and noise of all other sources which must be received and demodulated by the cable system headend. If a stray RF signal or noise were to enter a subscriber premise network, it would exit the premise network and enter the larger, outside cable plant. Because of the noise funneling nature of the reverse cable plant, RF noise from this one source would be superimposed on the valid signals of all other NIUs on that particular fiber node. In the forward path, proper carrier-to-noise (CNR) levels provide for clear video quality with gradual, visible degradation as noise levels rise. However, in the return path, the effect of high levels of RF noise and ingress is to lower CNR levels of the return RF signals and may seriously damage or destroy the ability of NIUs to communicate or, in the case of spread spectrum technology, drastically slow down network performance. It has become widely accepted that 95% of RF ingress problems in the reverse path comes from the drop and subscriber premise portion of the cable network, and only five percent of unwanted noise in the return path originates in the trunk or feeder network.

The presence and effect of unwanted RF noise in a cable system will be a function of several factors: The tightness of the cable system, the presence of external carriers, the material used in the construction of the cable system drops, the amount of shielding present on the drop cables and within the premise distribution network, and the alignment of the cable plant, among others. Unfortunately, there are several other transmission impediments that also degrade the reverse path performance and exacerbate the effects of stray and interfering carriers on the upstream RF spectrum.

One of these related matters is concerned with the concept of unity gain. Unity gain is defined as a uniform loss from the cable system headend to the subscriber premise. Stated another way, the concept of unity gain states that all signals transmitted from the cable headend should be received at all subscriber's premise at the same level and implies that the RF loss or attenuation from the cable system headend to every subscriber's premise wiring is uniform or the same. For instance, if a video signal is injected into the cable system headend at +54 dBmV then most cable systems would like to see the signal enter the subscriber premise network at a signal level of +10 dBmV. Likewise, if unity gain were to exist in the reverse direction, a signal that exits the subscriber premise network at +50 dBmV should be received at the headend at the same level, say nominally +10 dBmV. However, the reverse path of most cable systems today is not engineered to support unity gain.

The reason is that the loss plan for the forward direction of the cable plant (or high frequency portion of the cable plant) is not the same as that for the reverse direction or low frequency portion of the cable plant due to the fact that cable loss increases with higher frequency. In a 0.5 inch coax distribution cable, the loss at 600 MHz might be 2 dB per 100 feet while at 15 MHz the loss in the same cable would be approximately 0.2 dB per 100 feet. For a 1000-foot cable run, the difference in the cable loss for the forward and reverse directions would be approximately 18 dB.

Consider the specific problem of the cable system shown in FIG. 1. For a subscriber connected to a typical cable distribution network, the signal loss from the last distribution amplifier will be a combination of the trunk losses, the RF directional coupler (also known as taps) losses, and the drop cable. For a subscriber located nearest the last two way amplifier, attenuation in the both the forward and reverse direction will be primarily due to the losses in the RF directional coupler. As one moves further away from the last two-way amplifier, loss in the forward direction is the result of a combination of distribution trunk losses as well as tap (directional coupler) losses. At the last directional coupler, losses will be dominated by the trunk cable loss (20 dB) as opposed to the directional coupler loss (10 dB). The problem in the reverse direction is somewhat different. As subscribers move further from the last two way amplifier, trunk cable losses remain minimal and the dominant portion of the loss budget is the RF directional coupler. For a subscriber connected to the last directional coupler, the RF loss or attenuation by the cable distribution system is minimal—on the order of 2 dB—and the majority of the return path loss budget is due to the 10 dB directional coupler. The result is that signals input at the furthest drop in the cable system suffer less attenuation than those input from the directional couplers nearest the amplifier. Therefore, signals that are input into the reverse amplifier may vary by as much as 18-20 dB depending on whether they entered the reverse cable path at the first or last directional coupler.

This situation is shown in FIG. 1A for the forward path and FIG. 1B for the reverse path. One of the operational side effects of this is that RF signals exiting every subscriber premise network do not arrive at the first amplifier (or subsequent return amplifiers and by extrapolation, the cable system headend) at the same nominal level. Besides the obvious effect that an amplifier might go into overload, it becomes difficult to calculate the Carrier-to-Noise Ratio (CNR) and predict the expected system transmission performance when:

the input signal varies as a function of which port the signal was input into the return path network, and

the interfering noise level is also a function of which port the noise signal was input into the return path network.

One partial solution to this problem of having too large a dynamic range in terms of the range of signals that are received at the first reverse amplifier is to adjust the strength of the NIU's transmitter such that all signals received at the first return amplifier are at the same RF signal level. This approach results in having NIUs attached to directional couplers furthest from last amplifier reduce the strength of their transmitted signal on the order of 15-20 dB.

The problem with this approach to organizing the return path of a cable system is that the cable system is now more susceptible to noise that enters through directional couplers furthest from the first return amplifier A second problem with this approach is that reducing the NIU transmitter signal strength substantially reduces the Carrier to Noise (C/N) of the return signal. For example, as per FIG. 1, if a severe noise signal of strength 25 dBmV enters the cable system at the tap nearest the first return amplifier, it will hit the first amplifier with a strength of −6 dBmV. The majority of attenuation of the noise signal in this first case is from the 30 dB directional coupler. If the same strength noise signal enters the outside cable plant from the last directional coupler, it will hit the reverse amplifier at a signal strength of +12 dBmV since it will suffer only 3 dB of attenuation in the cable plant and 10 dB of attenuation in the last directional coupler. Interfering noise signals which enter the cable plant through the last directional coupler have the effect of reducing the C/N of NIU based RF signals in the return path by as much as 18 dB. The Carrier to Noise ratio under this situation could be as low as 10 dB, which is inadequate for most two-way cable applications.

Given the above example, it becomes apparent that cable system operators must take every means possible to remove interfering noise signals from the reverse path of the cable plant. If the noise energy can be attenuated another 10 dB such that the C/N of an NIU's signal is approximately 20 dB, the reverse transmission path will operate adequately for most cable modem services. However, any rise in the noise power by 1-3 dB could result in highly errored traffic in the reverse signal path. Among the steps to remove the major sources of ingress and noise from entering the outside distribution plant are tightening and properly grounding the outside distribution system plant and monitoring its performance monthly.

The problem the cable operators now face is how to attack the second, and larger source of ingress noise, the customer premise distribution system. Since the subscriber premise network is typically outside of the control and ownership of the cable operator, very little has and can be done to monitor and control this portion of the cable plant. This fact has led to the following problem—most, if not all, of the noise introduced in the return path of today's two-way HFC network originates within the subscriber's premise cable system network.

Ingress within the subscriber premise can occur when subscribers build out their premise cable plant and do not use high quality, heavily shielded cable, do not use high quality splitters, do not terminate unused drops, and do not attach connectors properly, among other causes. Up to this time, the collective wisdom of the cable industry has been that there is really nothing that can be done to improve the subscriber's premise network short of removing and replacing it with a new distribution system. This approach has been, for the most part, rejected for reasons of cost and the belief that this will not solve the noise problem because cable subscribers will, over time, modify and build out these networks and the cable operator will be left with the same problem after incurring the cost of replacing the premise network.

One tactic that has been used is to place a high-pass or band pass filter at the access point to the premise distribution network. Use of a high pass filter prevents any signal, noise or NIU signal, from exiting the premise distribution network and entering the return path of the cable system. Use of a bandpass filters centered around a specific return spectrum RF channel allows for all of the NIU signal and the noise energy within the band to enter the outside cable plant. Another approach has been to place special, heavily shielded drops from the access point of the outside cable plant to only those locations where NIUs will be placed, specifically interactive digital set top boxes and cable modems. Again, this solution is expensive and is still subject to noise and interfering signals being superimposed on the “connector cables” between the wall and the NIU.

In summary, current solutions to prevent RF Ingress Noise from the subscriber premise wiring network from entering the outside cable network have been limited to placing high pass filters on the access point to each subscriber's network that do not pass frequencies below 50 MHz, placing bandpass filters on two-way activated premises that pass only a portion of the spectrum and noise from each subscriber's premise network, rewiring the subscriber's premise with new heavier gauge cable that is more thoroughly shielded, and the use of spread spectrum modulation techniques to allow signals to coexist with Ingress Noise. The problem with all of these solutions is that they really do not solve the problem of noise egressing from the premise network into the outside cable plant. These approaches only mask or delay when the problem begins to affect the outside cable network and its performance. Specifically, the problem that network operators face is two-fold: how to reduce the amount of noise which emanates from the premise network and how to ensure that all signals that hit the reverse cable amplifier are within a specific range (±3 dB from nominal) without having all reverse signals on the cable plant paying a noise floor penalty with respect to ingress and noise which enters the reverse cable plant through directional couplers located furthest (or stated another way, through low loss reverse paths of the cable plant) from the reverse amplifier.

### SUMMARY OF THE INVENTION

This invention is predicated on the following assumptions:

Most of the RF ingress noise that originates within a two-way cable system originates or enters the outside cable system from the subscriber's premise network.

The subscriber's premise cable network is substandard in terms of shielding and terminations.

The subscriber's premise cable system wiring will be subjected to high levels of RF noise from AC motors, fluorescent lights, 60 cycle noise, and other subscriber based noise and interference sources.

The subscriber's premise distribution system is unlikely to ever be replaced, and even if it were replaced, would still be a source of noise into the outside cable system.

Historically, cable systems have viewed the premise distribution system as an extension of the drop system and cable plant. It is my opinion that the premise distribution system is a separate and distinct network from the cable drop and overall cable system. It is my intention to show how to provide a way to effectively isolate the reverse RF path of the home distribution network—and the noise and interference normally carried on such a network—from the overall cable distribution network while still allowing NIU based reverse path signals to pass between these two networks. As such, two approaches have been designed to allow the cable operator to deploy networks that allow the reverse bandwidth of the cable system to operate with minimal impact on the performance of the return RF spectrum when connected to noisy, subscriber premise wiring networks.

The first embodiment consists of two devices, one active and one passive as shown in FIG. 2. The passive unit consists of a pair of diplex filters connected end to end, as shown in FIG. 2, which segregates the RF traffic into a forward (nominally 50-750/850 MHz) and a reverse (nominally 5-30/36/42 MHz) direction. On the low band path of the diplex pair there is an attenuator which attenuates signals in the reverse direction by nominally 15-40 dB, depending upon the value chosen for the attenuator. The attenuator may be either fixed, variable, or a combination of both and will be chosen by the design rules described below. In the simplest situation, the passive unit is connected to both the premise distribution network and the outside cable plant at the demarcation point. The second unit of this embodiment is designated the active unit. The active unit consists of another set of diplex filters connected end to end but with an amplifier placed in the low band path.

In this system, signals in the forward or high band are passed from the outside cable system, through the passive unit and through the premise distribution network. Non two way activated devices can be connected to the premise distribution network and receive any of the signals in the forward or high band. For two way activated devices, forward signals pass through the active unit and are terminated on the NIU. Signals in the forward band pass through the passive unit, the premise distribution network, and the active unit without any processing or modification, except for some minor attenuation (1-1.5dB. Note that additional attenuation or amplification could be applied to the forward path RF spectrum at either the passive or active unit without affecting the scope of this invention.

In this system, the active unit is attached directly to an NIU and then to the premise distribution network. The NIU is attached to the end of the active unit that allows signals from the NIU to be amplified as they pass through the active unit. The active unit is designed to boost the signal placed on the reverse path of the premise network before it is superimposed with the noise present within the subscriber's premise network. In the first embodiment, the active unit is designed to be placed next to any active NIU (cable modem, active set top box, etc.) and to increase the return path signal strength by approximately 15-20 dB. The amplified return path RF signal is then connected to the home premise wiring network. At a second point in the network, typically at the side of the home where the residential premise network connects to the outside cable plant, the network passes through the second attenuating unit. The amplified RF signal and all noise that has entered the premise network cable system in the reverse path is attenuated and then passed through to the outside cable plant.

The attenuation of the second unit is chosen to be large enough that the strength of the largest signal that the NIU could provide to the input of the active unit, upon passing through the active unit, the premise network, the passive, attenuating unit, the RF directional couplers and the cable plant to the reverse amplifier that the received signal at the reverse amplifier will be at the nominal level necessary for optimum, reverse path operation without causing the reverse amplifier to be driven into a state of either compression or overload. Amplifying the return path RF signal from the NIU before it enters the premise distribution network has the effect of increasing the signal before it has had a chance to combine with the noise of the premise distribution network. The effect is that the amplified signal that reaches the second, passive unit has a higher C/N than the unamplified signal. Use of the attenuator as part of the system combination has multiple benefits: first, it forces the NIU to transmit at maximum signal level into the active unit and to pass through the premise network with the greatest possible signal level. When the NIU signal is mixed with noise, the C/N of the resultant signal before it enters the passive unit is as high as can practically be maintained. Second, attenuating all signals in the reverse path has the affect of reducing the noise that enters the outside cable plant from the premise network by 15 to 35 dB (depending upon amount of amplification and location relative to reverse amplifier). Third, it provides unity gain on the reverse path of the cable system without making the reverse path more susceptible to noise. Ideally, all return NIU RF signals that reach the first return amplifier are of the same signal strength while in practice, they are within a range of ±3 dB of the optimum signal level while accomplishing the secondary objective of limiting the amount of noise that can enter the reverse RF path of the overall cable system from premise networks connected to directional couplers furthest from the last amplifier.

The second embodiment is shown in FIG. 3 and consists of two active devices. The intent of this invention is to shift all communication in the reverse direction within the premise cable network from the low communications band of 5-30/36/42 MHz to a part of the RF spectrum less susceptible to noise and interference, nominally, 900 to 950 MHz or higher, and is designated here the new return high band spectrum. Again, signals in the forward or high band are passed through the system without any processing or modification, except for some minor attenuation (1-1.5 dB) of the forward signal for passing through the two devices. Note again that additional attenuation or amplification could be applied to the forward path RF spectrum without affecting the scope of this invention. Return path signals from NIUs are frequency translated to the new return band at an active unit located at or in an NIU and transmitted on the new return high band spectrum within the premise distribution network. At the interface between the premise distribution network and the cable system plant, signals from the new high band return spectrum are down converted back to the 5-30/36/42 MHz return band by a second active device. This system is designed to provide nominally 15-35 dB of noise isolation to the outside cable system distribution plant from the premise distribution network. Use of the new high band return spectrum minimizes noise being introduced into the reverse cable spectrum because: first, the new high band spectrum is located in a part of the RF spectrum in which there is considerable less high power noise sources, and second, the premise distribution cable plant provides better shielding at higher frequencies since the skin depth at the higher frequency is considerably shorter than in the low band frequency range. Unity gain is achieved in the cable upstream direction by adjusting the gain of the return signal at the second active device such that all signals that hit the first return amplifier are adjusted to within ±3 dB of optimum.

### BRIEF DESCRIPTION OF THE DRAWINGS

FIG. 1 shows the loss plan for the forward and reverse direction of an ordinary cable plant from the last amplifier to the premise network.

FIG. 2 shows a block diagram of the active and passive units for the first noise reduction system including the premise distribution network and connection to the outside cable plant.

FIG. 3 shows a block diagram of the two active units for the second noise reduction system including the premise distribution network and connection to the outside cable plant.

### DESCRIPTION OF THE INVENTION

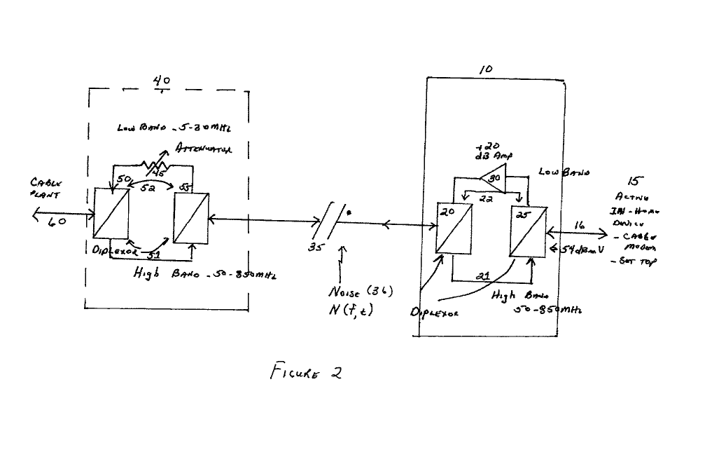

The first embodiment, shown in FIG. 2, consists of two devices 10 and 40, one active (10) and one passive(40). The system is designed to boost signals transmitted on the reverse spectrum placed on the subscriber's premise network 35 before it is corrupted by noise 36 which enters the premise network 35. The active unit 10 consists of a set of diplex filters, 20 and 25, that separate the forward (50-750/850 MHz) path, 21, and reverse (5-30/36/42 MHz) RF path, 22, and a booster amplifier 30 which is placed in the reverse bandwidth path 22. The active unit 10 is placed immediately next to an NIU 15 such as a digital set top box or a cable data modem. Signals from the outside cable plant 60 in the 50-750/850 MHz spectrum enter the passive unit 40 and pass through the high pass portion of diplex filters 50 and 55 via path 51 and are directed to the premise cable network 35 where they are broadcast to all attached devices. These high band signals then enter the active device 10, pass through diplex filters 20 and 25 on the high pass path 21, and are transmitted through a short length of coax cable 16 to NIU 15.

Signals transmitted in the reverse RF spectrum (5-30/36/42 MHz) from the NIU 15 pass through the short coax cable 16 and enter active unit 10. The modulation type, form, and amplitude of the reverse transmitted signal is of no particular importance here but are designated as a(f,t) where f designates that signal amplitude has some frequency within the reverse RF spectrum and some time dependency. These signals pass through diplex filter 25 and are directed to the low band path 22. These signals are then passed through booster amp 30 which only amplifies signals in the reverse path by an amount G which gives the input signal a(f,t) the form Ga(f,t) at the booster amplifier output. This signal is connected to the low band port of diplex filter 20 and transmitted out on the premise cable wiring 35 to passive unit 40.

While signal Ga(f,t) is transmitted through the premise cable wiring, it is expected that it will have noise of the form N(f,t) 36 superimposed on the it. Again, the formulation N(f,t) designates that the signal amplitude of the noise will be a function of frequency and time. At the connection point between the premise cable wiring network 35 and the outside cable plant 60 resides passive unit 40. The passive unit 40, as stated before, consists of a set of diplex filters 50 and 55 that separate the forward (50-750/850 MHz) path 51 and reverse (5-30/36/42 MHz) path 52 and an attenuator 45 which is placed in the reverse bandwidth path. The passive unit 40 is placed such that all signals entering or leaving the premise distribution network 35 must pass through the passive unit 40. The passive unit 40 is designed to attenuate only the reverse signal by some amount, nominally 20-40 dB. The reverse path signal and noise signal that enter passive unit 40 at diplexor 55 have the form (Ga(f,t)+N(f,t)) and assumes that the reverse path signal and noise signals are not attenuated significantly within the premise wiring network. The attenuator 45 can be either variable or fixed. The overall attenuation for part 45 will be designated as A.

The design of the overall system is such each booster amp in unit 10 increases the amplitude of the transmitted signal a(f,t) by an amount G before noise in the premise wiring network has a chance to be superimposed on signal a(f,t). In contrast, the passive unit located at the side of the residence attenuates all signals in the reverse direction by an amount A. This padding or attenuation of the reverse signal has two benefits, it reduces the effect of RF noise picked up within the premise wiring network by an amount N(f,t)/A that enters the outside cable system.

The choice of the amount of attenuation chosen for unit 40 is as follows. It is assumed that the NIU has a transmitter which has a variable power output which will vary from a(f,t)_{MIN} to a(f,t)_{MAX}. Typically, the difference in the power output of the NIU from a(f,t)_{MIN} to a(f,t)_{MAX} is approximately 20-30 dB. The choice of power output for the NIU may either be set manually or as a function of some communication protocol between the NIU and the cable system headend. The attenuation of unit 40 should be chosen such that NIU 15 must transmit at its highest possible value before being input into active unit 10 and would be given by the relationship:

Passive Unit Attenuation (dB)=a(f,t)_{MAX}+Gain of Active Amplifier (dB) (1)

Home Distribution Network Loss (dB)

Drop Cable Loss (dB)

RF Directional Coupler Loss (dB)

Cable Loss to First Return Amplifier (dB) (including Insertion Loss of all Intermediate Directional Couplers)

Optimum Signal Level of First Return Amplifier (dBmV)

In the situation in which there are two or more NIUs located within and connected to a premise distribution network, each NIU should have its own active unit and the single premise distribution network can share the passive unit. In the situation in which there are two or more NIUs located within and connected to a premise distribution network in which each NIU has a different a_{K}(f,t)_{MAX}, the NIU with the largest a_{K}(f,t)_{MAX} should be used for the calculating the attenuation. In most instances, several of the terms will be estimated. The loss in the Home Distribution Network will be estimated by the splitting loss of the first RF splitter which breaks the home network into multiple individual runs (for example, a single drop would have a loss of 0 dB, a two way splitter—3.5 dB, a four way splitter—8.5 dB, and an eight way splitter—10.5 dB). The drop cable loss would be estimated at 0.5-1.5 dB depending upon drop cable length and the cable loss to the first return amplifier will typically be estimated from the “as builds” which shows the number and values of RF directional couplers and the amount of cable between a particular site and the first return amplifier.

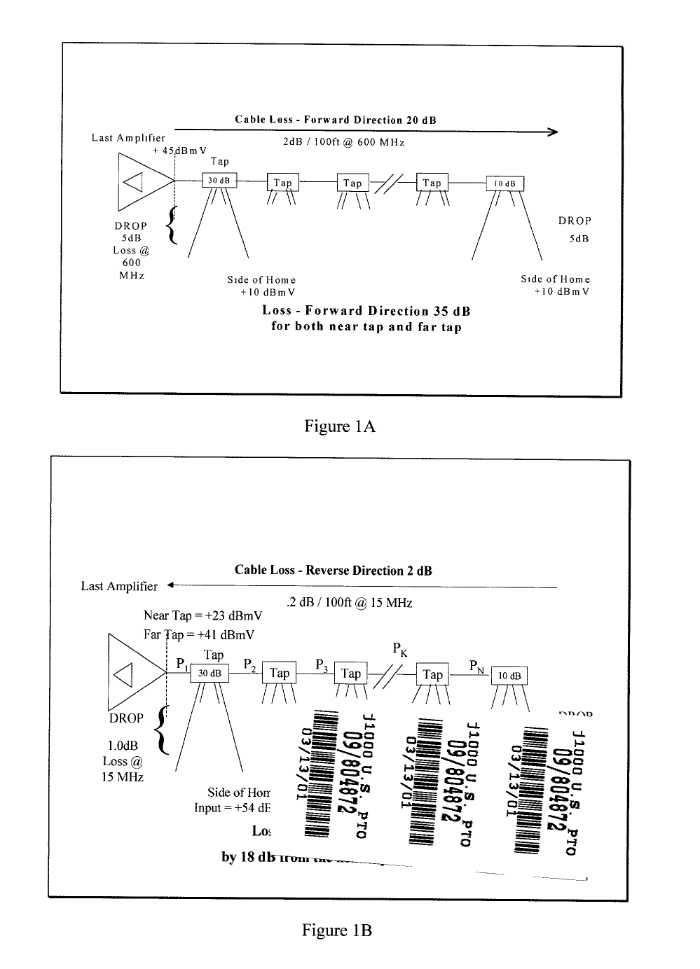

The above methodology, when compared to the previous situation shown in FIG. 1B, shows the following improvements. Assuming that a(f,t)_{MAX}=54 dBmV, that N(f,t)=+25 dBmV, that the Optimum Signal Level at the first return RF amplifier=23 dBmV, that the Home Network Loss=0 dB (single drop), then the signal level, noise floor level, and C/N contribution from Drop A and Drop B for both the conventional and proposed design methodology are shown in Table 1 below:

| | Current Cable Networks | Proposed |
|---|---|---|
| a(f, t)_{MAX} | 54 dBmV | 54 dBmV |
| Drop A - a(f, t) @ NIU | 54 dBmV | 54 dBmV |
| Drop B - a(f, t) @ NIU | 36 dBmV | 54 dBmV |
| N (f, t) | +25 dBmV | +25 dBmV |
| Optimum Signal Level @ | +23 dBmV | +23 dBmV |
| First Return Amplifier | | |
| Home Network Loss | 0 dB | 0 dB |
| Drop Loss | 1 dB | 1 dB |
| Drop A - Directional | 30 dB | 30 dB |
| Coupler Loss | | |
| Drop B - Directional | 10 dB | 10 dB |
| Coupler Loss | | |
| Drop A - Cable Loss | 0 dB | 0 dB |
| Drop B - Cable Loss | 2 dB | 2 dB |
| Active Unit Gain | — | 15 dB |
| Signal Levels @ Point C | | |
| Drop A - a(f, t) | +23 dBmV | +23 dBmV |
| Drop A - N(f, t) | −6 dBmV | −21 dBmV |
| C/N from Drop A | +29 dB | +44 dB |
| Drop B - a(f, t) | +23 dBmV | +23 dBmV |
| Drop B - N(f, t) | +12 dBmV | −21 dBmV |
| C/N from Drop B | +11 dB | +44 dB |
| Noise Floor | +12 dBmV | −21 dBmV |

The C/N improvement of the signals from directional couplers closest to the first return amplifier is determined by the gain of the amplifier in the active unit. The C/N improvement from directional couplers furthest from the first return amplifier is due to a combination of the amplifier gain and attenuator in the passive unit. Note that this invention provides a C/N improvement for all types of RF carriers in the return path for the premise distribution network regardless of modulation format i.e. QPSK, QAM, spread spectrum, etc.

It should be noted that the above calculations are for single carriers on a cable system. The overall situation could be considerably worse than outlined above and points out the need for this type of product. If the cable system is, in fact, equipped such that all drops on the network are equipped for two way service, then the noise floor presented to the first amplifier will be sum of all the noise and interfering signals from all of the premise distribution networks. For the situation in the second column above—Current Cable Networks—the problem one faces is the noise is a function of multiple sources of differing. Assuming that there is a worst case noise source of strength +25 dBmV originating in each premise distribution network, that the fiber node passes and is connected to 400 subscriber residences (premise distribution networks), that the majority of the noise transmitted into the reverse direction of the cable plant is from 10% of the residences connected to the far end RF directional couplers, then the increase in the noise floor as measured at the reverse amplifier would be equal to the Noise Floor for a Single Carrier +10 log N, where N is equal to the number of noise sources. Since we have assumed in this case that N=40, then the Noise Floor would be increased by 16 dB to +28 dBmV. As can be seen, this is greater than both the reverse signal level as well as the optimum reverse amplifier input point, so all two way communications would be impossible. Note, even if the worst case interfering signal were decreased by 20 dB, the Noise Floor would be somewhere on the order of +8 dBmV at the reverse amplifier and C/N of any transmitted signal would be on the order of 15 dB.

In contrast, in the case of the proposed invention, assuming a worst case noise source of strength +25 dBmV originating in each premise distribution network, that the fiber node passes and is connected to 400 subscriber residences (premise distribution networks), that the majority of the noise transmitted into the reverse direction of the cable plant is from 10% of the residences connected to the any of the RF directional couplers, then the noise floor at the reverse amplifier would be increase 16 dB to −5 dBmV and the C/N of a signal in the reverse direction would be 28 dB.

It should be noted that the location of the return path amplifier and attenuator need not be limited to the locations that were outlined above. In a cost reduced embodiment of the above, the return path amplifier could be built into the NIU. The maximum amount of power usually transmitted by NIUs on a cable plant is usually limited to ≦54 dBmV or 6 dBm in 6 MHz of spectrum and in any case, the maximum power level does not exceed 60 dBmV. It is the purpose of this invention to increase the transmitted power to a value considerably above what is traditionally found on a cable system and then to attenuate the signal before it is input to the first return amplifier. Of course, other power levels either higher or lower than discussed here could be chosen, but the intent here is to increase the power levels on the premise distribution network where it is expected that it will be mixed with external noise signals to as high a level as practical.

Likewise, the passive attenuator need not be placed at the demarcation point between the premise wiring and the cable plant. The passive attenuator could be a standalone unit which is deployed like an equalizer (in the connotation used by the cable industry) for the reverse path as part of the cable plant, but with additional attenuation to account for the excess amplification added by the active unit. The cable based passive units would be positioned before each RF directional couplers at Points Pᵢ as shown in FIG. 1B. For a unit connected to the first directional coupler, the unit P₁ should still provide the same attenuation as given by relationship (1) above. However, the attenuation at all subsequent units P_{K} would be equal to the relationship (1) from above less the attenuation of units P₁ through P_{K-1} between the Kth tap and the last return amplifier. In such an implementation, the attenuation would be distributed among the multiple units between the last RF directional coupler and the reverse amplifier. In a variation of this implementation, the passive attenuators could be either built into the RF directional couplers themselves on the drop paths or built into the directional couplers as part of the reverse path insertion loss.

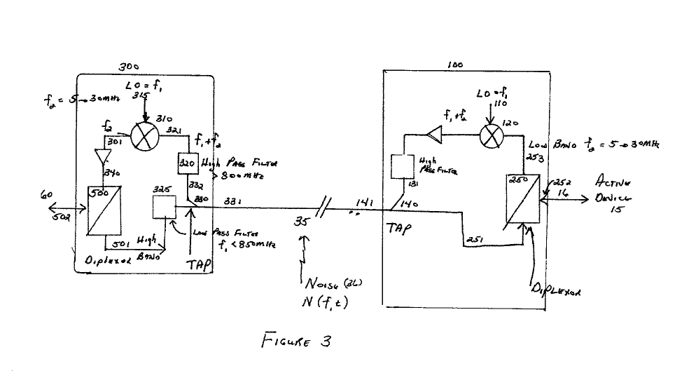

The second means for reducing the noise from subscriber premise cable distribution networks is shown in FIG. 3. It consists of two active devices 100 and 300. The intent of this means is to shift all communication in the reverse direction within the premise distribution network from the low communications band of 5-30/36/42 MHz to a part of the RF spectrum less susceptible to noise and interference. Signals from the outside cable plant 60 in the RF spectrum from 50-750/850 MHz enter the unit 300 via port 502 and pass through diplex filter 500 and follow path 501 out of the first active unit at port 331 onto the premise cable network 35. These signals then enter the active device 100 at port 141, pass through path 251 to diplex filter 250, exit unit 100 at port 252 and are transmitted through a short length of coax cable 16 to NIU 15. Reverse signals transmitted in the reverse RF spectrum (5-30 MHz) from the NIU 15 pass through the short coax cable 16 and enter active unit 100. The modulation type, form, and amplitude of the reverse transmitted signal is of no particular importance but are designated as a(f,t) where f designates that signal amplitude has some frequency and time dependency. These signals pass through diplexor 250 and are directed to the low band path 253.

The reverse path transmitted signal a(f,t) then enters mixer 120. Mixer 120 is also connected to local oscillator 110 with a frequency f₁, which is nominally 900 MHz. The output of mixer 120 should be a signal with a spectrum a(f+f₁,t), that is the output frequency is shifted in the frequency domain f+f₁, which should be above the frequency used in the forward path, that is from 50-750/850 MHz. The output of mixer 120 passes through amplifier 130 and then high band filter 131 which filters all frequencies below f₁.The output of amplifier 130 passes through reverse RF tap 140 and exits unit 100 via port 141. The high band return RF signal a(f+f₁,t) is then transmitted on the premise network wiring 35 to second active device 300 located at the connection point between the subscriber's premise network wiring 35 and the outside cable network wiring 60. The high band RF return signal a(f+f₁,t) enters unit 300 via port 331. A portion of the signal is directed via RF tap 330 along path 332 to another high pass filter 320 which removes any stray signals from the band 50-850 MHz. The output of the high pass filter 320 should be a(f+f₁,t) which is then input into mixer 310. Mixer 310 is also connected to Local Oscillator 315 with frequency f₁ such that the output of mixer 310 should be a(f,t). This signal is fed into amplifier 340 that is then connected to the low frequency port of diplexor 500. The purpose of this design is to take the high frequency return path signal into unit 300 and return the signal to the appropriate return band 5-30/36/42 MHz at the proper amplitude. This system should provide 15-35 dB of noise isolation of the cable system distribution plant from the subscriber premise distribution system since the low band return path is not ever connected to the outside cable plant.

Having shown and described the preferred embodiment of the present invention, those skilled in the art will realize that various omissions, substitutions, and changes in form and details may be made without departing from the spirit of the invention. It is the intention, therefore, for the invention to be limited only as indicated by the scope of the following claims.

What is claimed:

1. In a cable communications system between a first location and a second location, the first location comprising an input and output to the cable communications system, the communications system comprised of two segments of RF bandwidth, a first segment of the RF bandwidth comprising a forward bandwidth capable of carrying one or more discrete RF channels from the cable system headend, through the cable network and from the second location to the first location, and a second segment of the RF bandwidth comprising a reverse bandwidth and capable of carrying one or more discrete RF channels from the first location to the second location and through the cable network to the cable system headend, the second location comprising an amplifier for the forward bandwidth and an amplifier for the reverse bandwidth, and a communication path from the first location to the second location partitioned into two parts, a first part starting at the first location and running to an intermediate location between the first location and the second location, the first part of the communications path being susceptible to noise signals entering the communications path both within and outside of the RF communications channels carried within the reverse bandwidth, and a second part of the communications path starting at the intermediate location and running to the second location, the second part of the communications path being more immune to noise signals entering the communications path both within and outside of the RF communications channels carried within the reverse bandwidth, a method of controlling and minimizing the amplitude of noise signals from passing from the first part of the communications path to the second part of the communications path comprising the steps of:
collecting all RF signals input into the first part of the communications path at the first location before noise signals are combined with the input signals;
amplifying all of the RF signals input into the first part of the communications path at the first location by an amount G;
transmitting the amplified input signal through the first part of the communications path; and
at a fourth location located in the second part of the communications path between the intermediate location and the second location, attenuating the amplified signals in the reverse bandwidth only to the degree necessary as not to cause the reverse amplifier located at the second location to go either into compression or overload.

2. A method as claimed in claim 1 where noise signal includes but is not limited to kT noise, impulse noise, ingress noise and any other external RF signals that are not part of a RF communications channels input at location 1.

3. A method as claimed in claim 1 wherein a communications channel a(f,t) is input at location 1.

4. A method as claimed in claim 2 wherein the amplitude of the input communications channel a(f,t) can be varied either manually or automatically via communications with the cable system headend.

5. A method as claimed in claims 3 and 4 wherein when the amplitude of the input communications channel is set to its maximum value, a(f,t)_{MAX}, the attenuation, A, which occurs at the fourth location within the second part of the communications path between the intermediate location and the second location, is set to a value such that the amplified signal when attenuated to Ga(f,t)_{MAX}/A in the reverse bandwidth does not cause the reverse amplifier located at the second location to go either into compression or overload.

6. In a cable communications system between a multiplicity of locations and a second location, the multiplicity of locations comprising multiple inputs and outputs to the cable communications system, the communications system comprised of two segments of RF bandwidth, a first segment of the RF bandwidth comprising a forward bandwidth and capable of carrying one or more discrete RF channels from the cable system headend, through the cable network and from the second location to the multiplicity of locations, and a second segment of the RF bandwidth comprising a reverse bandwidth and capable of carrying one or more discrete RF channels from the multiplicity of locations to the second location and through the cable network to the cable system headend, the second location comprising an amplifier for the forward bandwidth and an amplifier for the reverse bandwidth, and a multiplicity of communication paths from each of the multiplicity of locations to the second location partitioned into two parts, a first part of each individual path starting at each of the multiplicity of locations and running to each of some multiplicity of intermediate locations between each of the multiplicity of locations and the second location, the first part of each of the multiple communications paths being susceptible to noise signals entering the communications path both within and outside of the RF communications channels carried within the reverse bandwidth, and a second part of the communications path starting at each of the multiplicity of intermediate locations and running to the second location, the second part of the multiple communications paths being more immune to noise signals entering the communications path both within and outside of the RF communications channels carried within the reverse bandwidth, a method of controlling and minimizing the amplitude of noise signals from passing from each of the multiple first parts of the communications path to each of the multiple second parts of the communications path comprising the steps of:
collecting all RF signals input into each of the multiple first parts of the communications paths at the multiplicity of locations before noise signals are combined with the multiple input signals;
amplifying each of the multiple RF signals input into the first part of the communications path at each of the multiple locations by an amount G;
transmitting each of the multiple amplified input signals through each of the multiple first parts of the communications paths; and
at each of some multiple locations within each of the multiple second parts of the communications paths between the multiple intermediate locations and the second location, attenuating each of the multiple amplified signals in the reverse bandwidth only to the degree necessary as not to cause the reverse amplifier located at the second location to go into either compression or overload.

7. A method as claimed in claim 6 wherein each of multiple communications channels a₁(f,t) through a_{N}(f,t) are each input at each of a multiplicity of locations.

8. A method as claimed in claim 7 wherein the amplitude of each of the multiple input communications channels a₁(f,t) through a_{N}(f,t) can each be varied either manually or automatically via communications with the cable system headend.

9. A method as claimed in claims 7 and 8 wherein when the amplitude of each of the multiple input communications channels are set to their individual maximum values, a₁(f,t)_{MAX} through a_{N}(f,t)_{MAX}, the attenuation, A₁ through A_{N}, which occurs at each of the multiplicity of locations, within the multiple second parts of the communications paths between the multiple intermediate locations and the second location, is set to a value such that the each of multiple amplified signals when attenuated to Ga_{K}(f,t)_{MAX}/A_{K} and the sum of each of the multiple amplified signals when attenuated SUM (Ga_{K}(f,t)_{MAX}/A_{K}) in the reverse bandwidth does not cause the reverse amplifier located at the second location to go either into compression or overload.

10. The method as described in claim 9 whereby the attenuation A_{K} for each reverse path 1 through N is optimized for each of the individual, amplified, maximum input information signals Ga₁(f,t)_{MAX} through Ga_{N}(f,t)_{MAX}.

11. The method as described in claim 10 whereby each of the attenuated input information signals (Gaₖ(f,t)_{MAX}/A_{K}) hit the first return amplifier at the second location at ±3 dB of the optimum return path signal for the amplifier.

12. The method as described in claim 10 whereby when there are two or more signals a₁(f,t) and a_{K}(f,t) input onto the same portion of the first part of the communication path and each signal is each amplified to Ga₁(f,t) and Ga_{K}(f,t), such that the amplified signals share the same means of attenuating the combined signals, A₁, the maximum attenuation value will be defined by the larger of the amplified return signals such that the attenuation is large enough not to cause the reverse amplifier located at the second location to go into either compression or overload.

13. In a cable communications system between a first location and a second location, the first location comprising an input and output to the cable communications system, the communications system comprised of two segments of RF bandwidth, a first segment of the RF bandwidth comprising a forward bandwidth capable of carrying one or more discrete RF channels from the cable system headend, through the cable network and from the second location to the first location, and a second segment of the RF bandwidth comprising a reverse bandwidth and capable of carrying one or more discrete RF channels from the first location to the second location and through the cable network to the cable system headend, the second location comprising an amplifier for the forward bandwidth and an amplifier for the reverse bandwidth, and a communication path from the first location to the second location partitioned into two parts, a first part starting at the first location and running to an intermediate location between the first location and the second location, the first part of the communications path being susceptible to noise signals entering the communications path both within and outside of the RF communications channels carried within the reverse bandwidth, and a second part of the communications path starting at the intermediate location and running to the second location, the second part of the communications path being more immune to noise signals entering the communications path both within and outside of the RF communications channels carried within the reverse bandwidth, a means of controlling and minimizing the amplitude of noise signals from passing from the first part of the communications path to the second part of the communications:
means of collecting all RF signals input into the first part of the communications path at the first location before noise and interfering signals are combined with the input signals;
means of amplifying all of the RF signals input into the first part of the communications path at the first location by an amount G and transmitting the amplified input signal through the first part of the communications path; and
means at a fourth location within the second part of the communications path between the intermediate location and the second location, attenuating the amplified signals in the reverse bandwidth only to the degree necessary as not to cause the reverse amplifier located at the second location to go either into compression or overload.

14. The system as claimed in claim 13 wherein the means of amplifying the input signals are part of the input device.

15. The system as claimed in claim 14 wherein the RF output of the input device is greater than 60 dBmV.

16. The system as claimed in claim 13 wherein the means of attenuating the return signal is part of a stand alone device mounted at or near the demarcation point at the customer premise.

17. The system as claimed in claim 13 wherein the means of attenuating the return signal is a fixed attenuator of a specific value.

18. The system as claimed in claim 13 wherein the means of attenuating the return signal is a variable attenuator over a specific range.

19. The system as claimed in claim 13 wherein the means of attenuating the return signal is a combination of a fixed and variable attenuator over a specific range.

20. The system as claimed in claim 13 wherein the means of attenuating the return signal is part of the cable network directional couplers and provide attenuation in the reverse bandwidth which is different than the coupling loss in the forward bandwidth.

21. The system as claimed in claim 13 wherein the means of attenuating the return signal is part of a stand alone device which is part of the return path of the overall cable plant and in which multiple devices provide additive and distributed attenuation in the reverse direction from the last directional coupler to the return amplifier at second location.

22. In a cable communications system between a first location and a second location, the first location comprising an input and output to the cable communications system, the communications system comprised of two segments of RF bandwidth, a first segment of the RF bandwidth comprising a forward bandwidth capable of carrying one or more discrete RF channels from the cable system headend, through the cable network and from the second location to the first location, and a second segment of the RF bandwidth comprising a reverse bandwidth and capable of carrying one or more discrete RF channels from the first location to the second location and through the cable network to the cable system headend, the second location comprising an amplifier for the forward bandwidth and an amplifier for the reverse bandwidth, and a communication path from the first location to the second location partitioned into two parts, a first part starting at the first location and running to an intermediate location between the first location and the second location, the first part of the communications path being susceptible to noise signals entering the communications path both within and outside of the RF communications channels carried within the reverse bandwidth, and a second part of the communications path starting at the intermediate location and running to the second location, the second part of the communications path being more immune to noise signals entering the communications path both within and outside of the RF communications channels carried within the reverse bandwidth, a method of controlling and minimizing the amplitude of noise signals from passing from the first part of the communications path to the second part of the communications path comprising the steps of:
collecting all RF signals input into the first part of the communications path at the first location before noise and interfering signals are combined with the input signals;
shifting all of the RF Input signals in a block to another portion of the RF spectrum, typically above the forward RF bandwidth, which is more immune to noise and interfering signals;
transmitting the frequency shifted input signals through the first part of the communications path;
at a fourth location within the second part of the communications path between the intermediate location and the second location, block downconverting the input signals to the normal reverse bandwidth; and
attenuating or amplifying the signals that are output from the downshifted frequency band such that these signals reach the second location at the optimum amplitude for transmission by the reverse amplifier and do not cause the reverse amplifier located at the second location to go into either compression or overload.
